(19) United States
(12) Patent Application Publication
(10) Pub. No.: US 2021/0329408 A1
(43) Pub. Date: Oct. 21, 2021

(54) METHOD FOR DETECTING A USER IN THE ENVIRONMENT OF A WORKSTATION

(71) Applicant: KESSEBÖHMER HOLDING KG, Bad Essen (DE)

(72) Inventors: Oliver SPAHN, Nieder-Ramstadt (DE); Sybille PÖHLER, Laichingen (DE); Rene BARKAU, Ostercappeln (DE); Hermann BUSCHERMÖHLE, Bersenbrück (DE)

(73) Assignee: KESSEBÖHMER HOLDING KG, Bad Essen (DE)

(21) Appl. No.: 17/273,304

(22) PCT Filed: Oct. 12, 2018
(86) PCT No.: PCT/EP2018/077902

§ 371 Date: Mar. 3, 2021

(51) Int. Cl. H04W 4/021; H04W 76/14; H04B 17/336

(52) U.S. Cl. CPC H04W 4/021; H04B 17/336; H04W 76/14

(57) ABSTRACT

A method of registering users in the ambient area of a workstation includes establishing a wireless communication link between an electronic workspace module positioned at a workstation and a mobile device and registering the entry of the mobile device into the ambient area of the workspace module by evaluating the signal characteristics of the communication link between the workspace module and the mobile device.

### BACKGROUND OF THE INVENTION

### 1. Field of the Invention

The invention relates to a method for registering users in the ambient area of a workstation by means of: establishing a wireless communication link between an electronic workspace module positioned at a workstation and a mobile device.

### 2. Discussion of the Related Art

Within modern corporate structures so-called desk-sharing systems are increasingly being used, whereby workstations are no longer assigned to specific employees, but instead can be used by different employees according to the equipment and subject to availability. Respective desk-sharing systems generally comprise a booking or reservation system, by means of which employees can book or rather reserve suitable workstations.

In this context there are also solutions already available whereby it is necessary for the user to register at the workstation. Such a registration can be used, for example, to identify the user so that user-specific workstation settings may be initialized via an appropriate control system. Familiar in the state-of-the-art are, for example, camera-based identification units which identify a person using a workstation on the basis of camera recordings. Furthermore, there are known solutions whereby the user is identified by means of reading personalized chip cards.

The well-known solutions for registering a user at a workstation are perceived as being complicated and inconvenient and thus compromise user acceptance of respective desk-sharing systems.

The aim of the invention therefore is to simplify the user registration in the ambient area of a workstation.

### SUMMARY OF THE INVENTION

The task is performed by a method of the aforementioned kind, whereby the entry of the mobile device into the ambient area of the workspace module is registered by means of establishing a wireless communication link between an electronic workspace module positioned at a workstation and the mobile device.

The invention draws on the knowledge that the signal characteristics of a communication link between a mobile device and an electronic workspace module allow conclusions regarding the relative position of the mobile device in respect to the workspace module. The signal characteristics of such a communication link are dependent on the distance between the communication parties and on possible interfering objects positioned between the communication parties. Relevant interfering objects may, for instance, be walls or partitions. On the basis of the signal characteristics of the communication link between an electronic workspace module positioned at a workstation and a mobile device it is therefore possible to determine whether the mobile device is already situated in the ambient area of a workstation.

The signal characteristics of the communication link can be evaluated by the electronic workspace module, the mobile device and/or a central computer unit connected for data transmission to the electronic workspace module and/or the mobile device.

In a preferred embodiment of the method according to invention the registration of the mobile device entering into the ambient area of the workspace module involves the recording of information in regard to the distance between the workspace module and the mobile device. As an example, the ambient area of the workstation can be defined by an ambient radius. Alternatively, the ambient area of a workstation may be predetermined by the given room structure. On the basis of the recorded distance information it is then possible to determine whether the mobile device is already located within the ambient radius or within the respective room. In the scope of evaluating the signal characteristics of the communication link, it can likewise be determined whether interfering objects, such as walls, are situated between the electronic workspace module and the mobile device. Specifically it is also possible, by evaluating the signal characteristics of the communication link, to determine which type of interfering objects are positioned between the electronic workspace module and the mobile device.

The mobile device is preferably designed as a smart phone or tablet. The mobile device is, notably, a portable cellular device. The electronic workspace module preferentially features a communication terminal comprising a transmitter and/or receiver module. The communication terminal is preferably adapted to establish a wireless communication link to the mobile device.

In another embodiment of the method according to invention the communication link between the workspace module and the mobile device is a direct connection, in particular a direct wireless connection. The communication link between the workspace module and the mobile device is, for instance, a direct Bluetooth connection. Alternatively, the communication link between the workspace module and the mobile device can also be an indirect connection comprising several single-link connections of a wireless local area network.

In another embodiment of the method according to invention evaluating the signal characteristics of the communication link involves the evaluation of the signal quality. In particular, the communication signal comprises both a desired signal and an interfering signal. The evaluation of the signal characteristics can hereby involve evaluating the desired signal and/or evaluating the interfering signal. Additionally, during the evaluation of the signal characteristics the desired signal and the interfering signal can be compared to one another and/or put in relation to each other.

In another embodiment of the method according to invention evaluating the signal characteristics of the communication link involves the evaluation of the signal noise. The signal noise represents an interference variable which is partly determined by the distance between the communication parties and/or depends on the interfering objects positioned between the communication parties. By means of evaluating the signal noise it can therefore be determined whether the mobile device is already located in the ambient area of the electronic workspace module situated at the workstation.

In a particularly preferred embodiment of the method according to invention evaluating the signal characteristics of the communication link involves determining the signal-to-noise ratio. The signal-to-noise ratio defines the relationship between the average power of the desired signal and the mean noise power of the interfering signal. On the basis of the signal-to-noise ratio of the communication link it is possible to derive relatively precise information relating to the distance between the communication parties. Consequently, it is possible to determine whether the mobile device is already located in the ambient area of the electronic workspace module.

In another embodiment of the method according to invention automatic identification of the mobile device and/or the user assigned to the mobile device is initiated due to the registration of the mobile device entering into the ambient area of the workspace module. By identifying the device, respectively the user, it can be determined which person is currently using the workstation concerned.

In a further embodiment the automatic retrieval of the device-specific and/or user-specific workstation settings from a central computer unit by means of the workspace module is initiated upon registering the entry of the mobile device into the ambient area of the workspace module. On the basis of the retrieved device-specific and/or user-specific workstation settings, the set-up of the device-specific and/or user-specific workstation settings by means of the workspace module can then automatically be initiated. The device-specific and/or user-specific workstation settings can alternatively or additionally be requested from the mobile device by means of the workspace module. The workstation settings may relate to the desktop height of a desk, the seat height and/or backrest tilt of a piece of seating furniture and/or the brightness and/or color of workstation lighting. The device-specific and/or user-specific workstation settings were either specified by the user or determined, notably calculated, on the basis of personal data made available by the user.

In another embodiment of the method according to invention the set-up of the device-specific and/or user-specific workstation settings involves recording the current desktop height of the desk assigned to the workstation by means of a sensor component and/or adjusting the desktop height of the desk assigned to the workstation by means of one or several of the actuators in the desk. Alternatively or additionally the set-up of the device-specific and/or user-specific workstation settings involves adjusting one or more lighting installations assigned to the workstation, particularly in regard to brightness and/or light color. Moreover, the set-up of the device-specific and/or user-specific workstation settings may involve recording the current seat height and/or backrest tilt of the seating furniture assigned to the workstation by means of one or several sensor components and/or adjusting the seat height and/or the backrest tilt of the seating furniture assigned to the workstation via one or several actuators in the seating furniture. As an example, distance measuring sensors which detect the distance between the desktop and the floor and the seat cushion and the floor respectively, can be used for recording the current desktop height and for recording the current seat height. For adjusting the desktop height of the desk and/or the seat height and/or backrest tilt of the seating furniture, electric motors can be applied as actuators.

In another embodiment of the method according to invention the set-up of the device-specific and/or user-specific workstation settings involve setting up a telephone number or telephone extension for a telephone assigned to the workstation and/or setting up a display on a digital frame assigned to the workstation. By setting up a telephone number or a telephone extension the user can be contacted at the workstation at a familiar telephone number or telephone extension accordingly. A personalized work environment can be created by setting up a display on the digital frame, depicting, for instance, the users personal photographs or favorite artists.

In addition, a method according to invention in which device-specific and/or user-specific workstation settings are calculated by means of the central computer unit on the basis of personal data provided by the user, is beneficial. The user, for example, makes personal data available relating to age, height and/or gender. Based on the personal data provided a suitable workstation configuration can then be determined by means of predetermined calculation routines. The suitable workstation configuration may, for example, relate to suitable light settings, a suitable seat height and/or a suitable desktop height.

All data and/or information relating to a user, shall be made anonymous for transmission.

The registration of a user in the ambient area of a workstation can occur in the framework of a method for managing workstations. Apart from registering a user, the method for managing workstations can include receiving workspace-related information from a plurality of electronic workspace modules assigned to a specific workstation via a central computer unit and providing the received workspace-related information for retrieval by mobile devices.

The method for managing workstations can involve evaluating the received workspace-related information by means of the central computer unit. The received workspace-related information is advantageously analyzed and processed in order to carry out subsequent measures. Hence the workspace-related information already available from an intracorporate booking system can be used for a plurality of further measures.

In a preferred embodiment of the method for managing workstations, the workspace-related information contains details relating to the items of office equipment located in the ambient area of the workstation assigned to the respective workspace module. Items of office equipment can, for instance, be desks, seating furniture, lights, telephones, computers, leaning aids, flip charts, roller cabinets and so forth. By making the details related to items of office equipment available via the central computer unit, this information can be retrieved by the mobile devices. The user of a respective mobile device can hereby inform him-/herself about the office equipment provided at different workstations in order to select and book a suitable workstation based on this information.

Data transmission between the individual workspace modules and the central computer unit shall preferably be wireless, in particular using radio communication, for example, via the mobile telephone system and/or the internet.

Moreover, a method for managing workstations is advantageous, whereby the details relating to the items of office equipment include designations of the items of office equipment located in the ambient area of the workstation assigned to the respective workspace module. Alternatively or additionally, the details relating to the items of office equipment include status information about the items of office equipment located in the ambient area of the workstation assigned to the respective workspace module. The designations of the equipment can comprise a literal description of the respective item of equipment and/or an identifier or a code. The status information about the respective items of equipment may contain a fault report and error codes, should an item of office equipment automatically detect a functional impairment or a defect. Preferentially, individual items of office equipment monitor their status automatically and report this status to the respective workspace module. In this way, a malfunctioning adjustable desk, for example, can be identified as being defect. On the other hand, for example, a functional impairment of a piece of seating furniture, a desk chair for instance, can be detected, should it not be able to be moved into a desired target position or not be able to hold a favored set position.

The method for managing workstations is further beneficially improved by establishing a wireless connection between a workspace module and one or several electronic management modules, each of which is situated on one of the items of office equipment located in the ambient area of a workstation. As an example, the management modules are in each case attached to the items of office equipment. For instance, one management module can be attached to the desk and a further management module to the seating furniture of a workstation, whereby the management modules can exchange data with the workspace module of a workstation via a wireless communication link. Alternatively or additionally the method comprises registering the items of office equipment located in the ambient area of a workstation by means of the electronic workspace module via the wireless connections to the respective management modules of the items of office equipment. Moreover, the method can comprise recording the designations of and/or status information about items of office equipment located in the ambient area of a workstation by means of the electronic workspace module via the wireless connection to the respective management modules of the items of office equipment. Preferably, the management modules monitor the status of the item of office equipment which the respective management modules are assigned to. For this purpose the electronic management modules can be connected to one or several sensors and/or one or several actuators of the respective item of office equipment. The electronic management modules can also be connected to a control feature of the respective item of office equipment or be integrated into the item of office equipment. By means of the wireless connection between the respective workspace modules and the management modules located in the ambient area of the workspace module an inventory can be carried out. The information provided by the management modules can be transmitted to the central computer unit accordingly and be evaluated in order to initiate subsequent measures. The items of office equipment can be actively administrated by the workspace module and/or be logged on to the workspace module via the wireless connection between the management module and the workspace module. The log-in can occur by means of the wireless transmission of an identifier from the management module of the respective items of office equipment to the workspace module, notably by means of a Bluetooth beacon. Via the wireless connection between the workspace module and the management modules, the presence of items of office equipment within the communication range of the workstation can be determined in real-time. Similarly, wrong items of office equipment actually assigned to a different workstation can be identified at a workstation, for instance. This makes it possible to find items of office equipment whose location have been changed, for example, by employees. By evaluating the workspace-related information, the verification of the inventory of each individual workstation is enabled. Should an error be identified in the context of the revision, the central computer unit can generate a corresponding reference and provide it to the user.

In a further embodiment of the method for managing workstations malfunctioning and/or defective office equipment is registered by the central computer unit by means of evaluating the received workspace-related information. As an example, the registration takes place by means of comparing the workspace-related information supplied by the workspace modules with equipment specifications stored in a memory of the central computer unit.

In another embodiment of the method for managing workstations necessary repairs, maintenance and/or inspection of the items of office equipment are registered by the central computer unit by means of evaluating the received workspace-related information. Alternatively or additionally the evaluation of the received workspace-related information takes place in order to register necessary maintenance and/or repair measures. Furthermore, repair orders can automatically be prepared or commissioned. Based on the transferred status information relating to the items of office equipment, for instance on the basis of the transmitted error codes, the central computer unit can identify suitable measures, whereby after identifying appropriate measures a member of staff, for example, can be entrusted with the deployment of necessary spare parts and/or tools at the workstation affected. Furthermore, maintenance on items of office equipment can be initiated should they have exceeded a defined service life. This way desks, seating furniture or light fittings for instance, can be serviced on reaching a predefined state of use. To that end, for example, the adjustment distance of an adjustable desk can be monitored so that maintenance of the desk can be initiated when the maximum value of an adjustment distance is exceeded. Furthermore, the service life or the quantity of light emitted by the lighting installation of a workstation can be monitored in such a manner that, on reaching a respective limit value, the central computer unit automatically issues an inspection order or commissions a facility management with one. As an example, a lighting installation, that does not emit the desired light output despite maximum power consumption as a result of being dirty, can automatically initiate a maintenance order such as a cleaning task.

In a further favored embodiment of the method for managing workstations the supply and/or status of expendable material consumed during usage by the items of office equipment located in the ambient area of a workstation is registered by means of the electronic workspace module via the wireless connection to the respective management modules of each item of workspace equipment. By evaluating the received workspace-related information by means of the central computer unit the necessity to provide a workstation with new expendable material is preferentially registered. Expendable material in this case can be printer paper, toner or flip-chart paper, for example. New expendable material may also be ordered by a user directly and specifically for a certain workstation by means of an application on the mobile device or a Bluetooth dash button. In addition, the user can initiate repairs, maintenance and/or inspection of an item of office equipment directly by means of the application on the mobile device. Moreover, the central computer unit can assign the expenses caused by measure to a cost unit. The cost unit can for instance be a department to which the generator of the costs, e.g. the user of a workstation, can be allocated.

In addition, a method for managing workstations is beneficial, whereby the workspace-related information includes details of the persons, either at the respective workstation assigned to the workspace module or who are located in the ambient area of the respective workstation assigned to the workspace module. In this way, the current location of a person or the workstation used by this person can be registered by a third party via the retrievable workspace-related information. As a result of this a significant disadvantage of desk-sharing systems can be overcome, namely, the association between departments or groups of people on the one hand and rooms, floors or buildings on the other. It is possible at all times to get an overview of the people located inside the building based on the personal data provided to the central computer unit.

Moreover, a method for managing workstations is beneficial, whereby the evaluation of the received workspace-related information takes place in order to deliver personal mail and/or parcels. On the basis of the workspace-related information it is possible to determine which workstation is currently being used by a mail addressee and/or parcel recipient, consequently enabling a corresponding delivery directly to the workstation.

In addition, a method for managing workstations is beneficial, whereby the configurations of the telephone system are automatically customized on the basis of either the received workspace-related information or the booking information available. Customizing the configurations of the telephone system preferably comprises assigning a personal telephone number or telephone extension to a telephone assigned to a specific workstation. When a person is registered at a workstation by the workspace module, it can in this way be achieved that the user of a workstation is accessible by phone at a familiar telephone number or extension. If personal identification does not occur directly at the workstation, the assignment of a telephone number or extension can also be realized based on the booking of the workstation made by a respective person.

The method for managing workstations is further beneficially improved in that a digital door sign can automatically be adapted on the basis of either the received workspace-related information or the booking information available. This way it can be avoided that persons or groups of people using spatially enclosed workstations, such as singular offices or conference rooms, are disturbed by a third party during usage. The automatic adaption of the door sign can for example involve displaying the booking duration on the door sign. Furthermore, information relating to the occupancy can be displayed by means of the digital door sign.

In an alternative embodiment of the method for managing workstations the workspace-related information includes information on the temperature and/or air quality at the workstation assigned to the respective workspace module. The temperature and/or air quality is preferentially registered at the respective workstations. Registering the temperature and/or air quality can for example be carried out by sensors of the respective workspace modules and/or sensors of the management modules.

In a further embodiment of the method for managing workstations the evaluation of the received workspace-related information by means of the central computer unit takes place in order to monitor the temperature and/or the air quality in a room, on a floor and/or in a building. By this means a possible cold source or rather cold zone of an area such as an open window can, for example, be identified. To minimize energy costs the open window can close automatically or a person can be instructed to close the window. Alternatively or additionally, monitoring the temperature and/or the air quality enables a cartographic representation of the temperature and/or air quality in a room, on a floor or in a building.

In addition, a method for managing workstations is beneficial, whereby the evaluation of the received workspace-related information by means of the central computer unit takes place in order to determine the number or the identities of people located in a room, on a floor and/or in a building, particularly in the case of an evacuation. The method therefore enables executing the effective and reliable supervision of an evacuation. This way the complete evacuation of a common area can be verified. By determining the identities individuals can specifically be searched for. Relevant position information makes it possible or easier to rescue people. In the case of fire persons inside a building can be identified and located so that emergency personnel can undertake a targeted rescue.

In a further preferred embodiment the method for managing workstations comprises the provision of a booking and/or reservation option for a workstation by means of an application on the mobile device. A user can request workspace-related information and/or occupancy information about a workstation from the central computer unit via the application installed on the mobile device. Ideally, the application on the mobile device assists the user with the booking of an appropriate workstation.

The method for managing workstations preferentially involves transmitting booking and/or reservation information from a mobile device to the central computer unit. The method can also involve transmitting booking and/or reservation information from the central computer unit to the workspace module of the workstation booked or reserved via the mobile device.

### BRIEF DESCRIPTION OF THE DRAWINGS

The preferred embodiments of the invention will, with reference to the attached images, be clarified and described below. Demonstrated here is in:

FIG. 1 a communication system while executing the method for managing workstations in a diagrammatic representation;

FIG. 2 the provision of management data for a central computer unit being used within the scope of the method for managing workstations;

FIG. 3 a mobile device while executing the method for managing workstations;

FIG. 4 a mobile device while executing the method for managing workstations;

FIG. 5 a mobile device while executing the method for managing workstations;

FIG. 6 a mobile device while executing the method for managing workstations; and

FIG. 7 a communication system while executing the method for registering users according to invention in a diagrammatic representation.

### DETAILED DESCRIPTION OF THE INVENTION

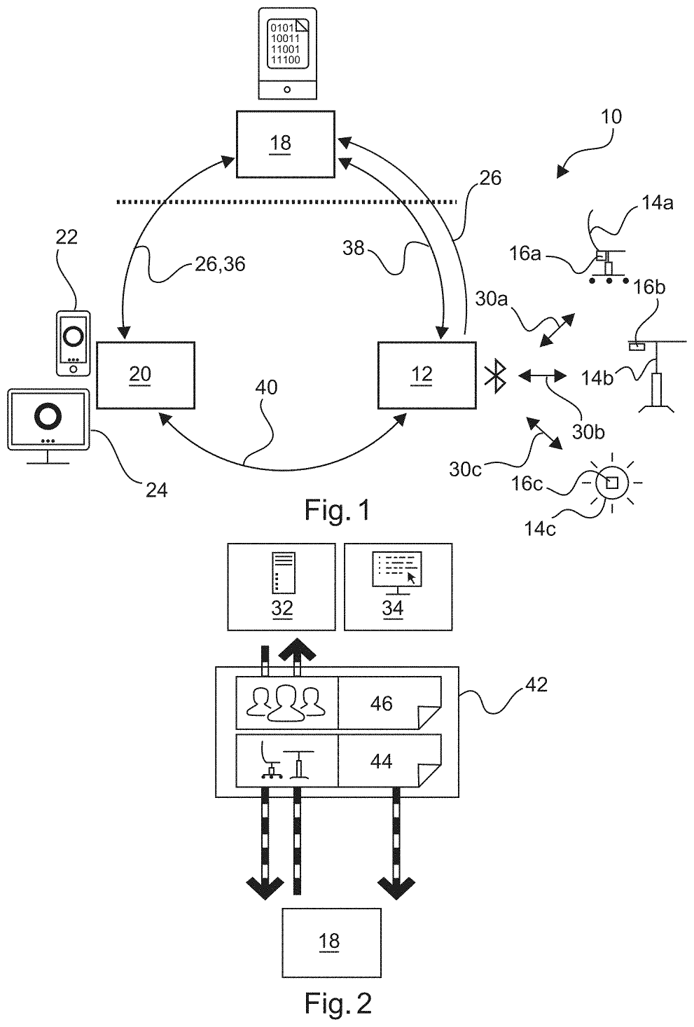

FIG. 1 demonstrates a communication system which can be used for managing workstations within a company. The communication system comprises several electronic workspace modules of which each is assigned to a workstation. Depicted as an example is the workspace module 12, which is assigned to the workstation 10.

The workspace module 12 is connected via a wireless connection, in this case a Bluetooth connection, to several electronic management modules 16a-16c, whereby each of the management modules 16a-16c is situated on one of the items of office equipment 14a-14c located in the ambient area of the workstation 10.

The management module 16a is situated on the item of office equipment 14a designed as a desk chair. The desk chair comprises actuators, by means of which the seat height and the backrest tilt are adjustable. The actuators of the item of office equipment 14a can be operated via the management module 16a, so that by means of appropriate commands the seat height and/or the backrest tilt are adjustable. The management module 16a is also applicable for registering the current seat height and the current backrest tilt. This, for example, can be carried out by means of recording and evaluating the adjustment procedures or through sensors suitable for this purpose.

The management module 16b is situated on the item of office equipment 14b designed as a desk. The desk is designed to be adjustable and features actuators for adjusting the desktop height. The management module 16b is connected to the actuators of the desk and is set up for the purpose of generating commands for the adjustment of the desktop height and making these available to the actuators. Furthermore, the current desktop height can be registered by means of the management module 16b. The registering of the desktop height can for example occur by means of a sensor recording the distance to the floor or by evaluating previous adjustment procedures.

The management module 16c is connected to the item of office equipment 14c designed as a lighting installation. The management module 16c is set up for the purpose of generating control commands for the adjustment of the brightness and/or the light color of the lighting installation and making these available to the lighting installation.

The electronic workspace module 12 registers the items of office equipment 14a-14c located in the ambient area of the workstation 10 via the wireless connection to the respective management modules 16a-16c of the items of office equipment 14a-14c. Via the wireless connections the electronic workspace module 12 records, on the one hand, the designations of the items of office equipment 14a-14c located in the ambient area of the workstation 10 and the status information about these items of office equipment 14a-14c, on the other hand. Moreover, control commands can be transmitted to the electronic management modules 16a-16c by means of the electronic workspace module 12 so that an adjustment of the status of each respective item of office equipment 14a-14c can take place on the basis of the control commands.

Consequently, the electronic management module 12 receives details 30a-30c relating to the items of office equipment 14a-14c located in the ambient area of the workstation 10 assigned to the workspace module 12. The details 30a-30c relating to the items of office equipment 14a-14c include designations of the items of office equipment 14a-14c located in the ambient area of the workstation 10 and status information about the items of office equipment 14a-14c located in the ambient area of the workstation 10.

Further items of office equipment, such as printers or flip charts, can also be equipped with corresponding management modules so that the workspace module 12 can receive or request the respective details relating to these items of office equipment. In this case the supply and/or status of expendable material could also be registered by the management modules so that this supply and/or status information can be provided to the workspace module. In this way the supply of printer or flip-chart paper, for example, can be registered. Alternatively or additionally the filling level of the toner cartridges can be registered.

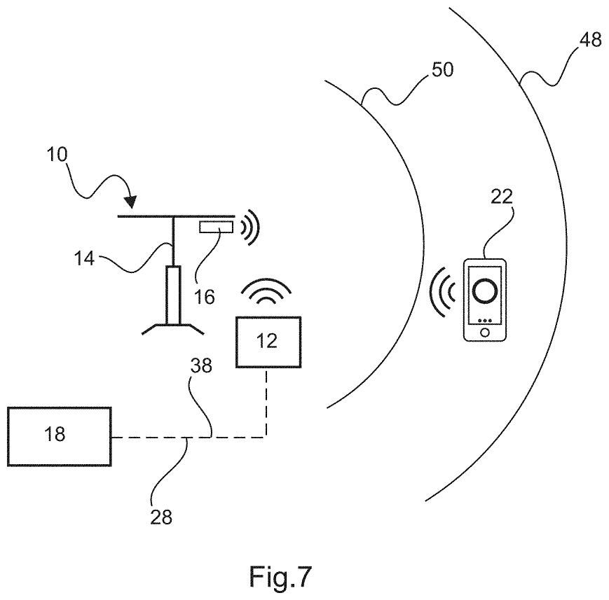

Furthermore, the workspace module 12 is capable of establishing a wireless connection to a mobile device 22 assigned to a specific person situated in the ambient area of the workstation 10. Via the wireless connection a person located in the ambient area of the workstation 10 can then be registered by means of the workspace module 12. In regard to the registering and identification of persons reference is made to FIG. 7.

The information provided to the electronic workstation 12 by the electronic management modules 16a-16c, as well as the information acquired by the electronic workspace module 12 itself, is provided to a central computer unit 18 in the form of workspace-related information 26. The provision of the workspace-related information 26 hereby occurs wirelessly, at least in part, whereby a wireless local area network and/or the internet can be used for data transmission. The workspace-related information 26 provided to the central computer unit 18 thus includes details 30a-30c relating to items of office equipment 14a-14c located in the ambient area of the workstation 10 and details 28 relating to persons located in the ambient area of the workstation 10.

The central computer unit 18 makes the received workspace-related information 26 available for retrieval by an application 20. The application 20 can be installed on a mobile device 22, for instance a smartphone or tablet, or on a stationary computer 24. By means of the application 20 users can inform themselves about the status and availability of workstations 10 and reserve or book suitable workstations 10.

Moreover, the central computer unit 18 evaluates the received workspace-related information 26 in order to derive subsequent measures based on the evaluation of the information. The evaluation of the received workspace-related information 26 takes place in order to register malfunctioning and/or defective office equipment. The details 30a-30c relating to the items of office equipment 14a-14c are hereby compared to stored equipment specifications. Furthermore, the evaluation of the received workspace-related information 26 takes place in order to register necessary repairs, maintenance and/or inspection of the items of office equipment 14a-14c. The central computer unit 18 automatically prepares repair orders or automatically issues internal and/or external repair orders accordingly. The received workspace-related information 26 can for example comprise error codes stored for the respective items of of office equipment 14a-14c, so that spare parts and/or tools can be deployed specifically to the affected workstation 10 on the basis of the received error codes. Furthermore, the service life and/or state of use of the items of office equipment 14a-14c can be monitored and evaluated by means of the central computer unit 18, so that on exceeding a predefined service life maintenance and/or inspection orders can be created and issued automatically by means of the central computer unit 18.

By evaluating the received workspace-related information 26 by means of the central computer unit 18 the necessity to provide the workstation 10 with new expendable material is also registered. This way, for example, necessary printer paper, flip-chart paper or toner cartridges can be specifically provided to the workstation 10.

The order of expendable material can however also be issued by means of the application 20 via a mobile device 22 or a stationary computer 24. Furthermore, the expendable material can be reordered directly via a dash button at the workstation 10. Repair, maintenance and/or inspection measures can also be initiated directly by the user via the application 20.

The evaluation of the received workspace-related information 26 by means of the central computer unit 18 additionally takes place in order to locate persons. This way it can be determined which workstation a person is currently using. This enables the delivery of person-related mail and/or parcels directly to a person's workstation 10. In addition, the telephone configurations can be customized based on this information so that a person-related telephone number or telephone extension is assigned to the telephone of workstation 10.

Furthermore, it is possible that the workspace-related information 26 includes information on the temperature and/or air quality at the respective workstation 10. The temperature and/or air quality can for example be recorded by the sensors of a workspace module 12. In this case the central computer unit 18 can evaluate the received workspace-related information 26 in order to monitor the temperature and/or air quality of a room, a floor and/or a building.

The evaluation of the received workspace-related information 26 by means of the central computer unit 18 can also occur in order to determine the number or the identities of persons situated in a room, on a floor and/or in a building in the case of an evacuation for instance. In this way the data evaluation by means of the central computer unit 18 enables executing the effective and reliable supervision of an evacuation. Consequently, the complete evacuation of a common area can be verified in that case. Furthermore, the workspace-related information 26 can be evaluated by means of the central computer unit 18 in order to locate a missing person enabling the emergency personnel in the case of evacuation to conduct a targeted search for this person.

The demonstrated communication system can also be used as a booking system for workstations 10. Via the application 20 users can search for appropriate workstations and book them for a limited time. In the context of a booking, booking information 36 is generated and provided to the central computer unit 18 by means of the application 20. In the central computer unit 18 person-related workstation settings are stored which are provided to the workspace module 12 of the booked workstation in the form of reservation information 38 by the central computer unit 18. As soon as the workspace module 12 registers the mobile device 22 of the person within the booking time in its own ambient area and authentication information 40 has been exchanged, the set-up of the personal workstation settings is initiated by the workspace module 12 of the booked workstation 10. As an example, the desk is automatically adjusted to an adequate desktop height. Furthermore, the seat height and/or backrest tilt of the desk chair can automatically be adjusted accordingly. Moreover, light settings preferred by the person can automatically be applied to the workstation 10.

For respective personal workstation settings to be provided to the workspace modules 12 by the central computer unit 18 it is necessary to provide the central computer unit 18 with setting information 42 in advance. The FIG. 2 demonstrates the provision of corresponding setting information for the central computer unit 18.

The setting information 42 can be provided to the central computer unit 18 by an existing booking system 32 previously used in a company. If the company has no available booking system 32, the provision of data 34 can occur manually. The setting information 42 required by the central computer unit 18 includes workstation details 44 and personal data 46.

The workstation details 44 comprise information on all of the workstations that shall be managed by the system. The workstation details 44 include, for example, the position of a workstation 10 and the intended equipment of a workstation 10. Furthermore, the workstation details 44 can include information on the setting and adjustment options of the office equipment. The personal data 46 relates to the employees of a company. The personal data can comprise the age, height and gender of individual persons. Furthermore, the personal data 46 can include the stored setting preferences of the respective persons, for instance a preferred lighting brightness at the workstation 10.

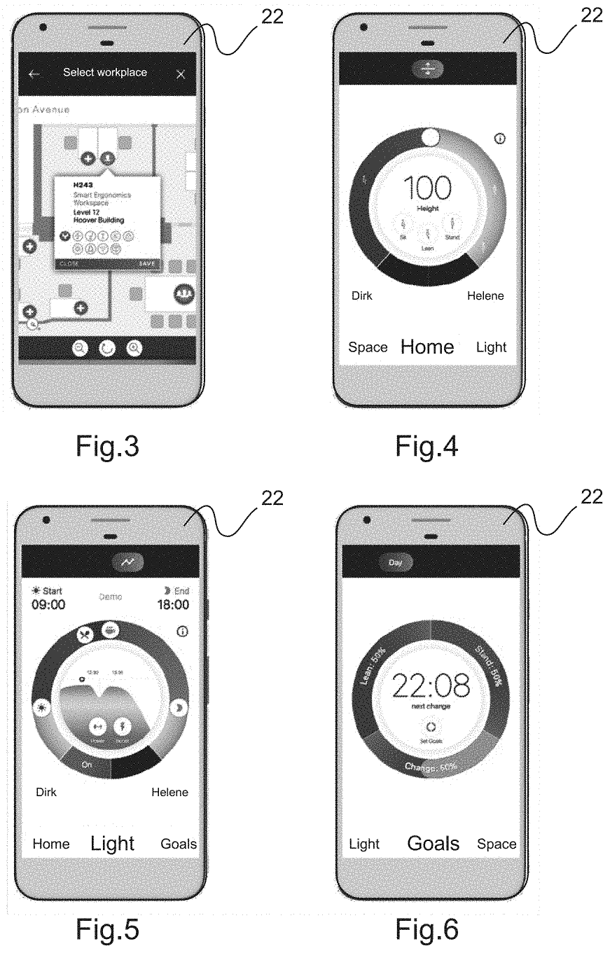

The FIG. 3 demonstrates a mobile device 22 during the booking of a workstation. The building structure as well as the layout of the different workstations is displayed to the user via an application. The application provides the user with supplementary information in regard to a selected workstation whereby the supplementary information includes position information. The position information comprises a building designation, a floor designation as well as a room designation. Furthermore, the user is provided with information on the office equipment. Based on this information the user is able to decide whether the selected workstation is suitable for the planned activity. Should this be the case the booking can be carried out accordingly by means of the application.

The FIG. 4 demonstrates a mobile device 22 by means of which the desktop height can be adjusted. Should a user wish to alter the desktop height of a workstation he can do so by means of the application on the mobile device 22. The application on the mobile device 22 notifies the central computer unit 18 in this case of the adjustment request, whereat the central computer unit 18 transmits respective setting information to the electronic workspace module 12 of the booked workstation 10. The electronic workspace module 12 of the workstation 10 transmits a command for height adjustment to the electronic management module linked to the desk. The electronic management module generates a control command and provides it to the height adjustment actuators of the desk whereupon a height adjustment is executed.

The FIG. 5 demonstrates a mobile device 22 providing the user with information on the current settings of the light installation at the booked workstation 10. Adequate light settings can be calculated on the basis of the provided personal data by means of a calculation formula. Additionally, a user can store preferred light settings and modify the light settings manually via the application on the mobile device 22. Furthermore, the lighting at the workstation 10 can automatically adjust itself in the course of the day and/or take the environmental conditions into account.

In FIG. 6 a mobile device 22 is depicted providing the user with information on stored goals. In the example given, the user is supposed to work standing 50% of the time and spend 50% of the working time seated whereby an adjustment of the desktop height can be executed by means of suitable actuators in the desk. The adjustment of the desktop height can be initiated automatically or activated manually by the user.

The FIG. 7 demonstrates a communication system during the registration of a user in the ambient area of a workstation 10. The user is registered via a mobile device 22 assigned to the user. The user and his mobile device 22 are located within a communication range 48, within which the mobile device 22 can establish a wireless communication link to an electronic workspace module 12 situated at the workstation 10. The electronic workspace module 12 is connected to a central computer unit 18 via a wireless connection, whereby workspace modules of other workstations not featured here are also connected via a wireless connection to the central computer unit 18. Reservation information 38 has already been made available to the workspace module 12 of the workstation 10, whereby the workspace module 12 was provided with details regarding the occupancy of the workstation 10 through the reservation information. Thus in the illustrated situation the workspace module 12 is in an acquisition mode which allows the registration of the user, expected in accordance to the reservation information 38, in the ambient area of the workstation 10.

The electronic workspace module 12 is furthermore connected via a wireless connection to an electronic management module 16 which in turn is linked to sensors and actuators of the height-adjustable desk 14. By means of the management module 16 an adjustment of the desktop height of the desk 14 can be initiated.

Because the electronic workspace module 12 is in acquisition mode, a wireless connection between the electronic workspace module 12 and the mobile device 22 was automatically established upon the entry of the mobile device 22 into the communication range 48. On the terminal side establishing the auto-connect was initiated by means of an application installed on the mobile device 22.

As soon as the user along with the mobile device 22 moves into the ambient area 50 of the workspace module 12, the workspace module 12 registers this. For this purpose the signal characteristics of the communication link between the workspace module 12 and the mobile device 22 are evaluated. The evaluation of the signal characteristics is in this case carried out by means of the electronic workspace module 12. In alternative embodiments the evaluation of the signal characteristics can similarly be carried out by means of the mobile device 22 and/or the central computer unit 18.

In the scope of the evaluation of the signal characteristics distance information is also determined in regard to the distance between the workspace module 12 and the mobile device 22. The communication link between the workspace module 12 and the mobile device 22 is a direct wireless connection that uses the Bluetooth standard. In the scope of the signal evaluation the technical signal quality of the communication signal between the workspace module 12 and the mobile device 22 is assessed by means of evaluating the signal noise. In this context the signal-to-noise-ratio of the communication link is determined and on the basis of the determined signal-to-noise-ratio it is established whether the mobile device 22 is already situated in the ambient area 50 of the workspace module 12.

Should the evaluation of the signal characteristics of the communication link have revealed that the mobile device 22 has already been moved into the ambient area 50, the mobile device 22 or a user assigned to the mobile device 22 is automatically identified. The user identification thereby initially occurs anonymously. Based on the identification of the user user-specific workstation settings can then be retrieved from the central computer unit 18 by means of the workspace module 12. The retrieved workstation settings thereby relate, for example, to an appropriate desktop height for the user of the mobile device 22. Provided that the workstation 10 has further items of office equipment at its disposal, the user-specific workstation settings can also comprise suitable settings for the other items of office equipment. Further items of office equipment are for instance an adjustable desk chair or an adjustable light installation. On the basis of the retrieved workstation settings the workspace module 12 initiates the set-up of the user-specific workstation settings for the respective items of office equipment 14.

In order to set an adequate desktop height for the user assigned to the mobile device 22, the current desktop height of the desk 14 assigned to the workstation 10 is determined by the means of sensors first. The sensor unit used for this purpose can for example be a component of the management module 16. Based on the current desktop height of the desk 14 the adjustment path for the desktop can be determined so that an adjustment of the desktop height of the desk 14 can take place by means of the actuators of the desk 14. The actuators of the desk 14 are preferably connected in a signal-conducting manner to the electronic management module 16.

Additionally, the lighting installations assigned to the workstation 10 and/or the desk chair assigned to the workstation 10 can be adjusted automatically on the basis of the retrieved user-specific workstation settings.

Furthermore, the set-up of the user-specific workstation settings can involve setting up a telephone number or telephone extension for a telephone assigned to the workstation 10. Moreover, the set-up of the user-specific workstation settings can involve setting up a display on a digital frame assigned to the workstation 10.

The user-specific workstation settings can be entered manually by the user in advance. Alternatively or additionally the central computer unit 18 can calculate user-specific workstation settings based on personal data provided in advance by the user. To this end, scientific evidence in terms of workspace illumination or the favorable duration of sitting and standing at an adjustable desk can hereby be incorporated. Personal data, on the basis of which the user-specific workstation settings are calculated by means of the central computer unit 18, can relate for instance to the height, the age or the gender of the respective user.

### REFERENCE SIGNS

10 workstation
12 workspace module
14, 14a-14c items of office equipment
16, 16a-16c management modules
18 central computer unit
20 application
22 mobile device
24 stationary computer
26 workspace-related information
28 person-related details
30a-30c details relating to items of office equipment
32 existing booking system
34 manual provision of data
36 booking information
38 reservation information
40 authentication information
42 setting information
44 workstation details
46 personal data
48 communication range
50 ambient area

1. A method of registering users in an ambient area of a workstation, the method comprising the steps of:
(a) establishing a wireless communication link between an electronic workspace module positioned at a workstation and a mobile device; and
(b) registering an entry of the mobile device into the ambient area of the electronic workspace module by evaluating signal characteristics of the wireless communication link between the electronic workspace module and the mobile device.

2. The method according to claim 1,
wherein step (b) is performed by recording information in regard to the distance between the electronic workspace module and the mobile device.

3. The method according to claim 1, wherein the communication link between the electronic workspace module and the mobile device is a direction connection.

4. The method according to claim 1, wherein evaluating the signal characteristics of the wireless communication link involves a evaluation of a signal quality.

5. The method according to claim 1, wherein evaluating the signal characteristics of the wireless communication link involves an evaluation of a signal noise.

6. The method according to claim 1, wherein evaluating the signal characteristics of the wireless communication link involves determining a signal-to-noise ratio.

7. The method according to claim 1,
subsequent to step (b) at least one of the following steps is initiated:
automatic identifying of the mobile deice or the user assigned to the mobile device;
automatically retrieving the device-specific or user-specific workstation settings from a central computer unit via the workspace module;
automatically initiating the set-up of the device-specific or user-specific workstation settings via the workspace module.

8. The method according to claim 1,
wherein subsequent to step (b), the step of
(c) automatically initiating the set-up of device-specific or user-specific workstation settings via the workspace module is performed; and
wherein subsequent to step (c) at least one of the following steps is performed:
recording a current desktop height of a desk assigned to the workstation via a sensor component;
adjusting the desktop height of the desk assigned to the workstation via one or several of actuators in the desk;
adjusting a lighting installation assigned to the workstation;
recording a current seat height or a backrest tilt of a seating furniture assigned to the workstation via the sensor components;
adjusting the seat height or the backrest tilt of the seating furniture assigned to the workstation via an actuator in the seating furniture.

9. The method according to claim 1,
wherein subsequent to step (b), the step of
(c) automatically initiating the set-up of device-specific or user-specific workstation settings via the workspace module is performed; and
wherein subsequent to step (c) at least one of the following steps is performed:
setting up a telephone number or telephone extension for a telephone assigned to the workstation
setting up a display on a digital frame assigned to the workstation.

10. The method according to claim 9,
wherein determining device-specific or user-specific workstation settings is performed via the central computer unit on the basis of personal data made available by a user.

11. The method according to claim 1, wherein the communication link between the electronic workspace module and the mobile device is a direct wireless connection.

12. The method according to claim 2, wherein the communication link between the electronic workspace module and the mobile device is a direct connection.

13. The method according to claim 2, wherein evaluating the signal characteristics of the wireless communication link involves an evaluation of a signal quality.

14. The method according to claim 2, wherein evaluating the signal characteristics of the wireless communication link involves an evaluation of a signal noise.

15. The method according to claim 2, wherein evaluating the signal characteristics of the wireless communication link involves determining a signal-to-noise ratio.

16. The method according to claim 2,
subsequent to step (b) at least one of the following steps is initiated:
automatic identifying of the mobile device or the user assigned to the mobile device;
automatically retrieving the device-specific or user-specific workstation settings from a central computer unit via the workspace module;
automatically initiating the set-up of the device-specific or user-specific workstation settings via the workspace module.
